(19) United States
(12) Patent Application Publication
(10) Pub. No.: US 2004/0016085 A1
(43) Pub. Date: Jan. 29, 2004

(54) Ball lock cable tie having stiffening ribs

(76) Inventor: Jack E. Caveney, Hinsdale, IL (US)

Correspondence Address: PANDUIT CORP., LEGAL DEPARTMENT - TP12, 17301 SOUTH RIDGELAND AVENUE, TINLEY PARK, IL, 60477, US

(21) Appl. No.: 10/613,062

(22) Filed: Jul. 3, 2003

Related U.S. Application Data
(60) Provisional application No. 60/397,838, filed on Jul. 23, 2002.

(51) Int. Cl. B65D 63/02; F16L 33/00

(52) U.S. Cl. 24/16 PB

(57) ABSTRACT

A metal cable tie is disclosed. The cable tie includes an elongate metallic strap, a metallic locking head, and metallic roller means. The strap has a first end and a second end opposite the first end. The head is secured to the first end of the strap for receiving the second end of the strap. The head comprises a strap entry face, a strap exit face, and a strap-receiving aperture extending therebetween. The head also comprises a floor and a roof which diverge in the direction of the exit face. The head further comprises at least one indentation on a first side thereof and at least one indentation on a second side thereof. The metallic roller means lockingly engages the strap, and the head comprises retention means disposed adjacent the exit face for captively holding the roller means within the head. The roller means is movable between a threading position wherein the roller means is disposed adjacent the exit face and the retention means, and a locking position wherein the roller means is closer to the entry face. The first end of the strap comprises at least one rib disposed adjacent the head.

### CROSS-REFERENCE TO RELATED APPLICATIONS

This Application claims priority to U.S. Provisional Application Serial No. 60/397,838, filed on Jul. 23, 2002.

### BACKGROUND OF THE INVENTION

The present invention is directed to a cable tie, and more particularly, to a three-piece metal cable tie that utilizes a roller means as the locking mechanism.

Metallic bundling devices incorporating locking balls and roller pins have been used for bundling bales of cotton or the like since the Nineteenth Century. None of the prior devices were positive locking, i.e. depending on the orientation of the locking head, gravity could hold the ball out of locking engagement with the strap resulting in release. U.S. Pat. No. 4,399,592 addressed this problem by teaching the addition of a raised portion or protuberance for deflecting the threaded strap away from the floor as the threaded strap exits the locking head. This deflection ensures that the locking ball is in continuous engagement with the threaded strap regardless of the position of the ball or the orientation of the locking head.

### SUMMARY OF THE INVENTION

It would be desirable to provide a cable tie having improved tensile strength.

It would also be desirable to provide a cable tie locking head having stiffening deformations in the side to increase locking head strength.

It would further be desirable to provide a cable tie strap having stiffening ribs along the return loop to increase return loop strength.

A metal cable tie is disclosed. The cable tie includes an elongate metallic strap, a metallic locking head, and metallic roller means. The strap has a first end and a second end opposite the first end. The head is secured to the. first end of the strap for receiving the second end of the strap. The head comprises a strap entry face, a strap exit face, and a strap-receiving aperture extending therebetween. The head also comprises a floor and a roof which diverge in the direction of the exit face. The head further comprises at least one indentation on a first side thereof and at least one indentation on a second side thereof. The metallic roller means lockingly engages the strap, and the head comprises retention means disposed adjacent the exit face for captively holding the roller means within the head. The roller means is movable between a threading position wherein the roller means is disposed adjacent the exit face and the retention means, and a locking position wherein the roller means is closer to the entry face. The first end of the strap comprises at least one rib disposed adjacent the head.

Preferably, the locking head has two indentations on the first side thereof and two indentations on the second side thereof.

Preferably, the first end of the strap has two ribs adjacent the locking h ad.

Preferably, the locking head has a lead-in portion at the entry face.

Preferably, the strap is coated.

Preferably, the roller means is a ball.

Preferably, the retention means is a finger extending from the roof adjacent the exit face.

### BRIEF DESCRIPTION OF FIGURES

FIG. 1 is a perspective view of the metal tie of the present invention shown secured around a bundle of wires;

FIG. 2 is a top perspective view of the cable tie of FIG. 1;

FIG. 3 is a top view of the cable tie of FIG. 1;

FIG. 4 is a side view of the cable tie of FIG. 1;

FIG. 5 is an end view of the cable tie of FIG. 1;

FIG. 6 is a partial exploded view of FIG. 2, with the strap portion separate from the locking head;

FIG. 7 is a bottom perspective view of a portion of the strap that engages the head;

FIG. 8 is a sectional view taken along lines 8-8 of FIG. 4;

FIG. 9 is a sectional view taken along lines 9-9 of FIG. 4;

FIG. 10 is a sectional view taken along lines 10-10 of FIG. 3;

FIG. 11 is a sectional view taken along lines 11-11 of FIG. 5;

FIG. 12 is a sectional view of the strap and locking head, which depicts the locking ball in its threading position;

FIG. 13 is a sectional view of the strap and locking head, which depicts the locking ball in its locking position; and

FIG. 14 is a sectional view taken along lines 14-14 of FIG. 13.

### DETAILED DESCRIPTION OF PREFERRED EMBODIMENTS

The illustrated embodiments of the invention are directed to a three-piece cable tie that utilizes a roller means as the locking mechanism.

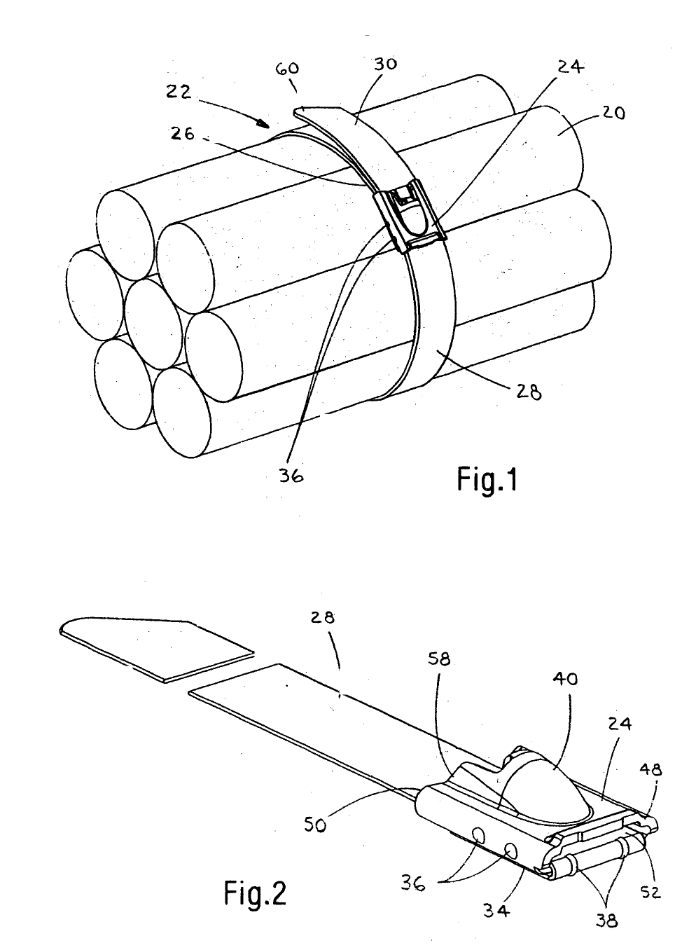

Referring now to the drawings, a cable tie for bundling a plurality of elongate objects, such as wires 20, and for holding objects together is generally indicated in FIG. 1 by reference numeral 22. Cable tie 22 includes a locking head 24 secured to a first end 26 of an elongate strap 28 for receiving a second end 30 of the strap 28, and roller means in the form of a ball or sphere 32, best shown in FIGS. 9-14, for retaining the strap 28 within the locking head 24. Preferably, the ball, head and strap are formed of stainless steel to allow the strap to be used over a wide temperature range and to give the cable tie high strength and excellent corrosion resistance. Additionally, as known in the art, the strap 28 may be coated.

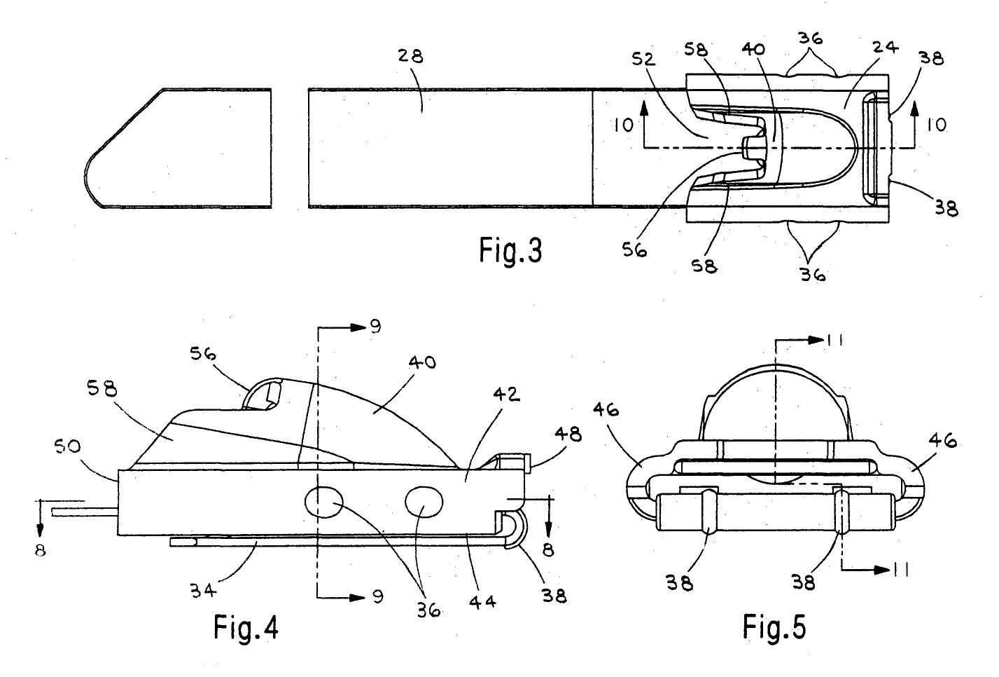

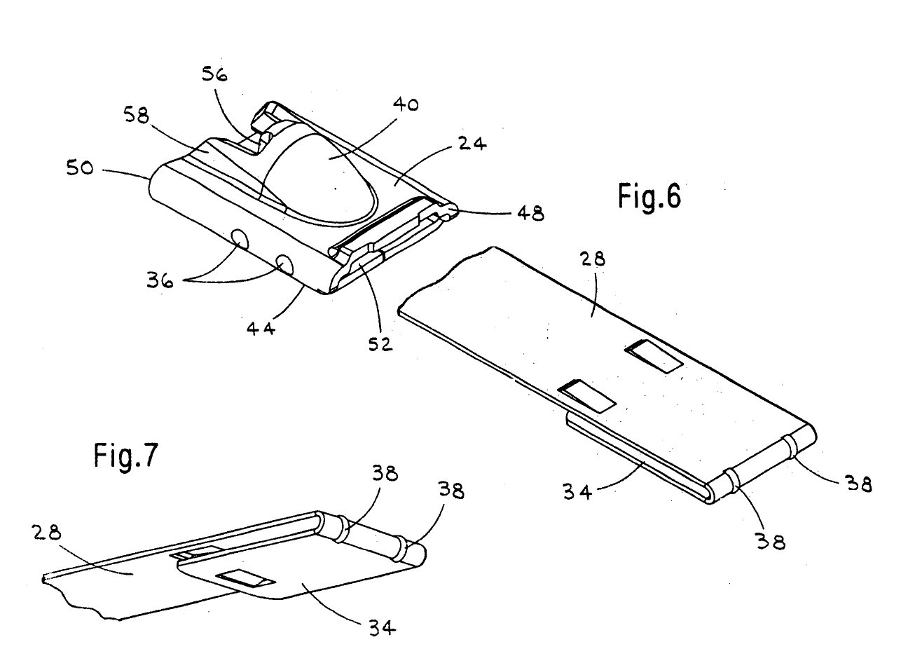

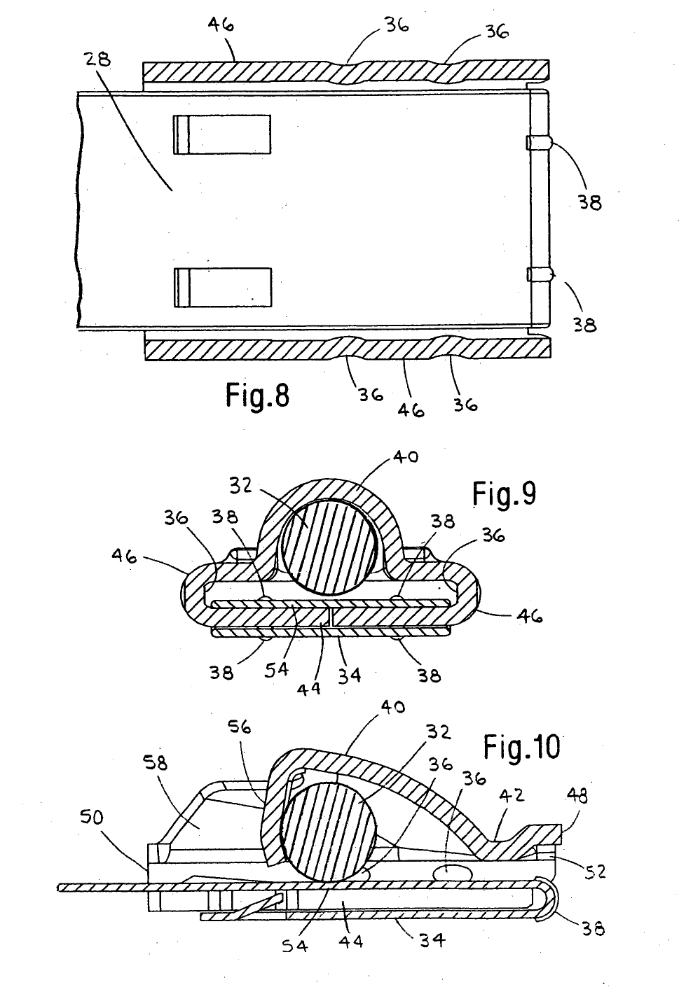

The cable tie of the present invention is formed by assembling a locking head 24, shown in FIGS. 2-5, a strap 28 and a hooked portion 34 formed integral with the strap 28 as shown in FIGS. 6 and 7. As best seen in FIG. 8, the locking head 24 has a plurality of stiffening deformations, such as deformation 36, in the sides of the locking head 24. Moreover, the strap 28 has a plurality of stiffening ribs, such as rib 38, near the first end 26 in the rear of the strap 28 at the return loop. The stiffening deformations and ribs provide additional strength to the locking head 24 and return loop, respectively, thus increasing the load at which the locking head 24 and return loop will unfold, especially when the locking head 24 is unsupported. As a result, the cable tie 22 has increased tensile strength.

Referring to FIGS. 9-14, locking head 24 comprises a roof 40, a ceiling 42, and a bottom wall 44 with the ceiling 42 and bottom wall 44 joined by a pair of sidewalls 46. As shown in FIGS. 10-13, the locking head 24 includes a strap entry face 48, a strap exit face 50, and a strap-receiving aperture 52 extending therebetween. The roof 40 and floor 54 diverge in the direction of the exit face 50.

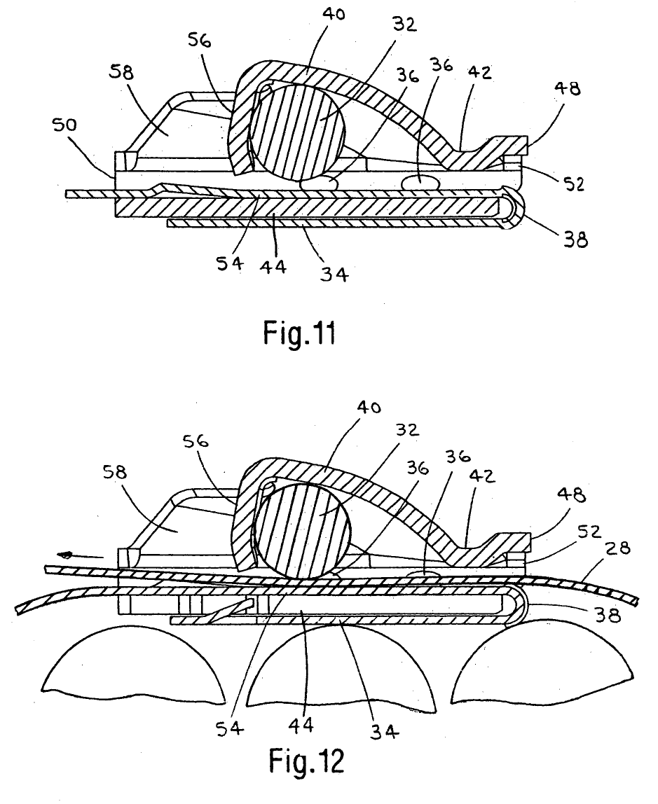

The ball 32 has a textured or roughened surface to increase its coefficient of friction with the strap 28. As best seen in FIGS. 11-12, the ball 32 is captively held between the roof 40 and floor 54 by retention means comprising a finger 56 extending from the roof 40 towards the floor 54 adjacent the exit face 50. One end of the roof 40 joins the ceiling 42 adjacent the entry face 48 with spaced wings 58 joining other parts of the roof 40 and ceiling 42.

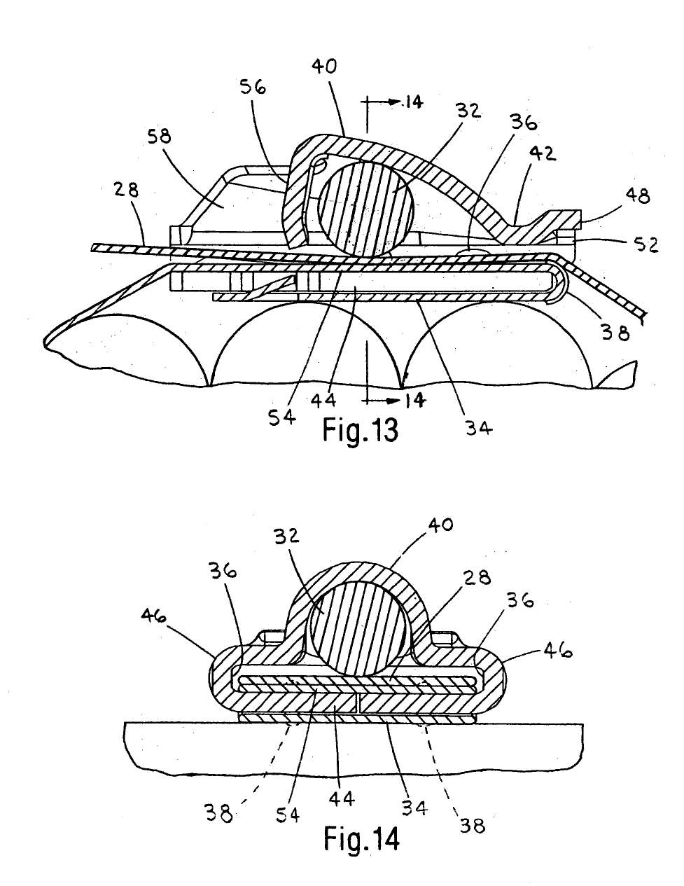

The locking ball 32 is movable between a threading position, shown in FIG. 12, wherein the ball 32 is disposed engaging finger 56 adjacent exit face 50 and a locking position, shown in FIG. 13, wherein the ball 32 is closer to entry face 48 and securely engages the threaded strap 28. In the threading position, the ball 32 concurrently engages the finger 56 and roof 40. In the locking position, the strap 28 is compressively held between the ball 32 and the floor 54.

As shown in FIGS. 10-13, locking head 24 includes a lead-in portion 60 at the strap entry face 48. The lead-in portion 60 facilitates the initial insertion of tip 62 into the locking head 24 and reduces installation time for threading the cable tie 22. Moreover, the lead-in portion 60 strengthens the top of the locking head 24. As the strap 28 enters the strap entry face 48, the strap 28 engages the lead-in portion 60 and the strap 28 is biased toward floor 54.

In operation, after the strap 28 is wrapped around the objects to be held, tip 62 is inserted into the locking head 24. Continued threading of the strap 28 results in positive engagement of the strap 28 and ball 32 at any angle the head 24 is held. After the strap 28 has been tightened and released, locking ball 32 moves to its locking position, shown in FIG. 13, where the strap 28 is compressively held between the ball 32 and the floor 54.

The disclosed invention provides a cable tie that utilizes a roller means as the locking mechanism. It should be noted that the above-described and illustrated embodiments and preferred embodiments of the invention are not an exhaustive listing of the forms such a cable tie in accordance with the invention might take; rather, they serve as exemplary and illustrative of embodiments of the invention as presently understood. By way of example, and without limitation, a cable tie locking head having more than two stiffening deformations on each side thereof is contemplated to be within the scope of the invention. Many other forms of the invention are believed to exist.

1. A cable tie, comprising:
an elongate metallic strap having a first end and a second end opposite the first end;
a metallic locking head secured to the first end of the strap for receiving the second end of the strap, the head comprising a strap entry face, a strap exit face, and a strap-receiving aperture extending therebetween, the head further comprising a floor and a roof which diverge in the direction of the exit face,
wherein the head comprises at least one indentation on a first side thereof and at least one indentation on a second side thereof; and
metallic roller means for lockingly engaging the strap, the head comprising retention means disposed adjacent the exit face for captively holding the roller means within the head,
the roller means being movable between a threading position wherein the roller means is disposed adjacent the exit face and the retention means, and a locking position wherein the roller means is closer to the entry face.

2. The cable tie of claim 1 wherein the head comprises two indentations on the first side thereof and two indentations of the second side thereof.

3. The cable tie of claim 1 wherein the head further comprises a lead-in portion at the entry face.

4. The cable tie of claim 1 wherein the strap is coated.

5. The cable tie of claim 1 wherein the roller means comprises a ball.

6. The cable tie of claim 1 wherein the retention means comprises a finger extending from the roof adjacent the exit face.

7. A cable tie, comprising:
an elongate metallic strap having a first end and a second end opposite the first end;
a metallic locking head secured to the first end of the strap for receiving the second end of the strap, the head comprising a strap entry face, a strap exit face, and a strap-receiving aperture extending therebetween, the head further comprising a floor and a roof which diverge in the direction of the exit face; and
metallic roller means for lockingly engaging the strap, the head comprising retention means disposed adjacent the exit face for captively holding the roller means within the head,
the roller means being movable between a threading position wherein the roller means is disposed adjacent the exit face and the retention means, and a locking position wherein the roller means is closer to the entry face,
wherein the first end of the strap comprises at least one rib disposed adjacent the head.

8. The cable tie of claim 7 wherein the first end of the strap comprises two ribs adjacent the head.

9. The cable tie of claim 7 wherein the head further comprises a lead-in portion at the entry face.

10. The cable tie of claim 7 wherein the strap is coated.

11. The cable tie of claim 7 wherein the roller means comprises a ball.

12. The cable tie of claim 7 wherein the retention means comprises a finger extending from the roof adjacent the exit face.

13. A cable tie, comprising:
an elongate metallic strap having a first end and a second end opposite the first end;
a metallic locking head secured to the first end of the strap for receiving the second end of the strap, the head comprising a strap entry face, a strap exit face, and a strap-receiving aperture extending therebetween, the head further comprising a floor and a roof which diverge in the direction of the exit face,
wherein the head comprises at least one indentation on a first side thereof and at least one indentation on a second side thereof; and
metallic roller means for lockingly engaging the strap, the head comprising retention means disposed adjacent the exit face for captively holding the roller means within the head,
the roller means being movable between a threading position wherein the roller means is disposed adjacent the exit face and the retention means, and a locking position wherein the roller means is closer to the entry face,
wherein the first end of the strap comprises at least one rib disposed adjacent the head.

14. The cable tie of claim 13 wherein the head comprises two indentations on the first side thereof and two indentations of the second side thereof.

15. The cable tie of claim 13 wherein the first end of the strap comprises two ribs adjacent the head.

16. The cable tie of claim 13 wherein the head further comprises a lead-in portion at the entry face.

17. The cable tie of claim 13 wherein the strap is coated.

18. The cable tie of claim 13 wherein the roller means comprises a ball.

19. The cable tie of claim 13 wherein the retention means comprises a finger extending from the roof adjacent the exit face.
